(19) United States
(12) Patent Application Publication
(10) Pub. No.: US 2017/0192794 A1
(43) Pub. Date: Jul. 6, 2017

(54) METHOD FOR FAST BOOTING/SHUTTING DOWN A COMPUTING SYSTEM BY CLUSTERING

(71) Applicant: National Chung Cheng University, Chia-Yi (TW)

(72) Inventors: Shi-Wu Lo, Chia-Yi (TW); Hung-Yi Lin, Chia-Yi (TW); Zheng-Yuan Chen, Chia-Yi (TW); Shen-Ta Hsieh, Chia-Yi (TW)

(21) Appl. No.: 15/219,876

(22) Filed: Jul. 26, 2016

(30) Foreign Application Priority Data
Jan. 5, 2016 (TW) 105100112

(51) Int. Cl. G06F 9/44

(52) U.S. Cl. CPC G06F 9/4401; G06F 9/4418; G06F 9/442

(57) ABSTRACT

Provided is a method for fast booting/shutting down a computing system. The method includes the steps of: when the computing system enters the hibernation mode, sorting the memory of the computing system into swappable pages and non-swappable pages and writing the non-swappable pages into a hibernation file of a storage device; determining whether the swappable pages are frequently-used pages or infrequently-used pages, and if the swappable pages are determined to be frequently-used pages, incorporating the frequently-used pages in the hibernation file; sorting the infrequently-used pages into clean pages and dirty pages; capturing one of the dirty pages and adding pages that are related to the captured page into at least one data set and placing the data set into a swap space of the storage device by continuous accessing process.

This application claims priority for Taiwan patent application no. 105100112 filed on Jan. 05, 2016, the content of which is incorporated by reference in its entirely.

### BACKGROUND OF THE INVENTION

Field of the Invention

The invention is related to a method for booting/shutting down a computing system, and more particularly to a method for fast booting/shutting down a computing system by sorting pages into frequently-used pages and infrequently-used pages, placing the frequently-used pages into a hibernation file, and clustering the infrequently-used pages.

Description of the Prior Art By using the state-of-the-art hibernation-based fast booting technique, computing devices can swap out all of the swappable pages in the memory and sort the pages into clean pages and dirty pages. If the pages that are swapped out are dirty pages, the computing devices write the dirty pages to a hibernation file and store the hibernation file in a swap space or a file system of a storage device. If the pages that are swapped out are clean pages, the computing system may store the clean pages in the file system or the swap space of the storage device, or ignore the clean pages instead of storing the clean pages.

Although the aforementioned method is capable of expediting the booting process, it is not the optimized method for booting a computing system. This is because the pages required in the booting process may be swapped out during the hibernation period instead of being incorporated in the hibernation file, and thus the booting speed is retarded.

In view of this drawback, the invention proposes a method for the better management of memory pages. The inventive method is featured in terms of the expedition of the booting/shutting down process of a computing system by: (1) placing swappable frequently-used pages in the hibernation file, and (2) adding swappable pages according to their correlations into data sets, in which each data set is written on a continuous address in the storage space. The foregoing drawback can be obviated by means of the inventive method.

### SUMMARY OF THE INVENTION

An object of the invention is to provide a method for fast booting/shutting down a computing system by swapping out infrequently-used pages and preserving frequently-used pages when the computing system enters the hibernation mode, thereby downsizing the hibernation file and reducing the time for reading the hibernation file during the booting process. More advantageously, the pages having a high correlation can be aggregated by way of logical clustering. As the operating system generally needs to read a number of pages, for example, the Linux operating system needs to read eight pages simultaneously, each page reading process allows the computing system to read in pages that are related with the pages to be read, thereby expediting the process for enabling the computing system to be recovered to the full-speed operating circumstances.

To this end, a computing system sorts at least one memory thereof into swappable pages and non-swappable pages, in which the non-swappable pages are written into a hibernation file, and the hibernation file is stored in at least one storage device. Next, the swappable pages are determined to be frequently-used pages or infrequently-used pages, and if the swappable pages are determined to be frequently-used pages, those frequently-used pages are incorporated in the hibernation file. Next, at least one infrequently-used page is captured, and the captured infrequently-used page is added into a data set along with pages that are related to the captured infrequently-used page, and the data set is placed in the swap space of the storage device. It is to be noted that the pages related to the captured infrequently-used pages may be infrequently-used pages. The above step is repeated until no pages are available to be captured. As a large number of the infrequently-used pages are correlated with each other, the number of the pages that are captured is less than the number of frequently-used pages. When the computing system is not able to capture more pages, it is indicated that the computing system has affiliated all of the pages in the memory with at least one data set, and the data sets are placed in the swap space by means of continuous access. Next, the computing system is rebooted such that the computing system can read the hibernation file from the storage device and store the hibernation file back to the memory. Finally, the computing system reads the data sets in the swap space from the storage device, and loads the data sets to the memory.

Now the foregoing and other features and advantages of the invention will be best understood through the following descriptions with reference to the accompanying drawings, in which:

### BRIEF DESCRIPTION OF THE DRAWINGS

FIG. 1 is the system block diagram showing the architecture of the invention according to a first embodiment of the invention;

FIG. 2 is a tree chart illustrating the method of the invention according to the first embodiment of the invention;

FIG. 3 is a flow chart illustrating the method of the invention according to the first embodiment of the invention;

FIG. 4 is a schematic diagram showing the clustering result made in terms of frequency according to the first embodiment of the invention;

FIG. 5 is a schematic diagram showing the clustering result made in terms of probability according to the first embodiment of the invention; and

FIG. 6 is the system block diagram showing the architecture of the invention according to a second embodiment of the invention.

### DESCRIPTION OF THE PREFERRED EMBODIMENTS

Several exemplary embodiments embodying the features and advantages of the invention will be expounded in following paragraphs of descriptions. It is to be realized that the present invention is allowed to have various modification in different respects, all of which are without departing from the scope of the present invention, and the description herein and the drawings are to be taken as illustrative in nature, but not to be taken as a confinement for the invention.

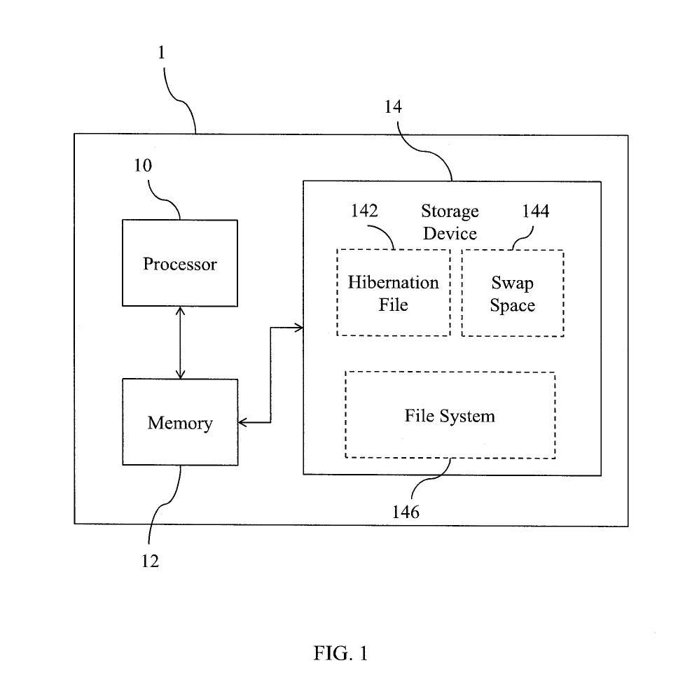

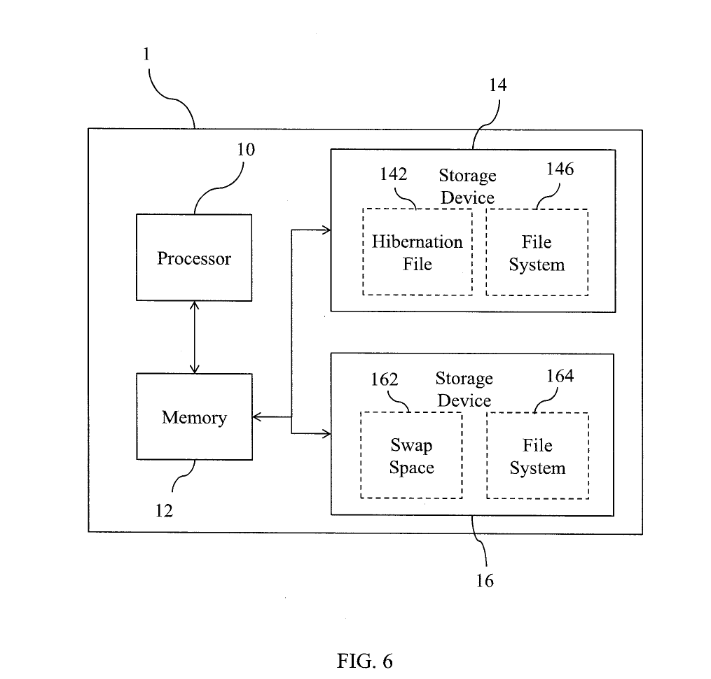

Referring to FIG. 1, a system block diagram according to a first embodiment of the invention is shown. A computing system 1 includes a processor 10 connected to a memory 12 and a storage device 14. The storage device 14 allows a hibernation file 142, a swap space 144, and a file system 146 to be stored therein. The storage device 14 may be a high-speed random access memory, such as a flash memory, or a high-speed random and continuous access memory, such as a hybrid hard drive. A hybrid hard drive is typically made up of a flash memory and a hard drive. In case that only one storage device 14 exists in the computing system 1, the storage device 14 is preferably made up of a high-speed random access memory, such as a flash memory, so as to store the hibernation file 142, the swap space 144, and the file system 146 therein. When the storage device 14 is made up of a hybrid hard drive, as shown in FIG. 6, the hibernation file 142 and a portion of the file system 147 are placed in a storage device 14 having high-speed sequential reading characteristics, and the swap space 162 and the other portion of the file system 164 are placed in a storage device 16 having high-speed random access characteristics.

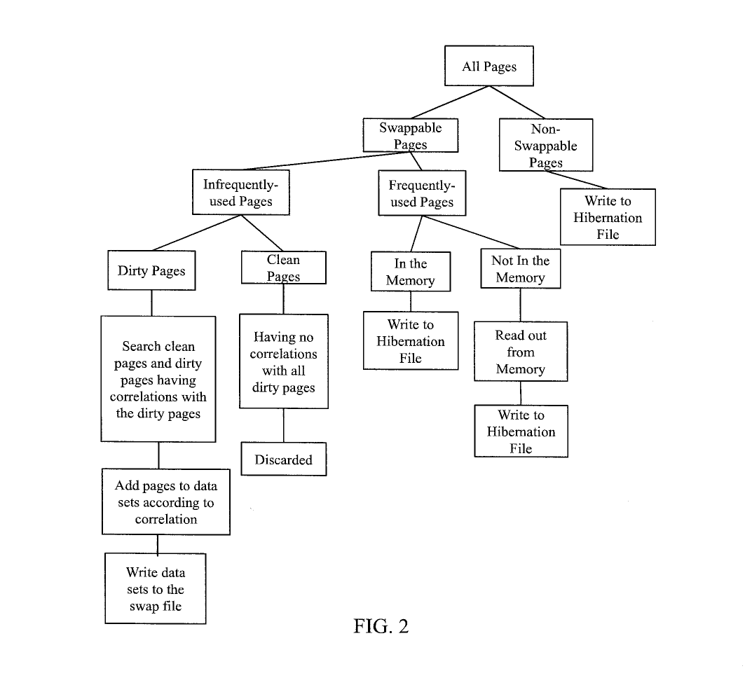

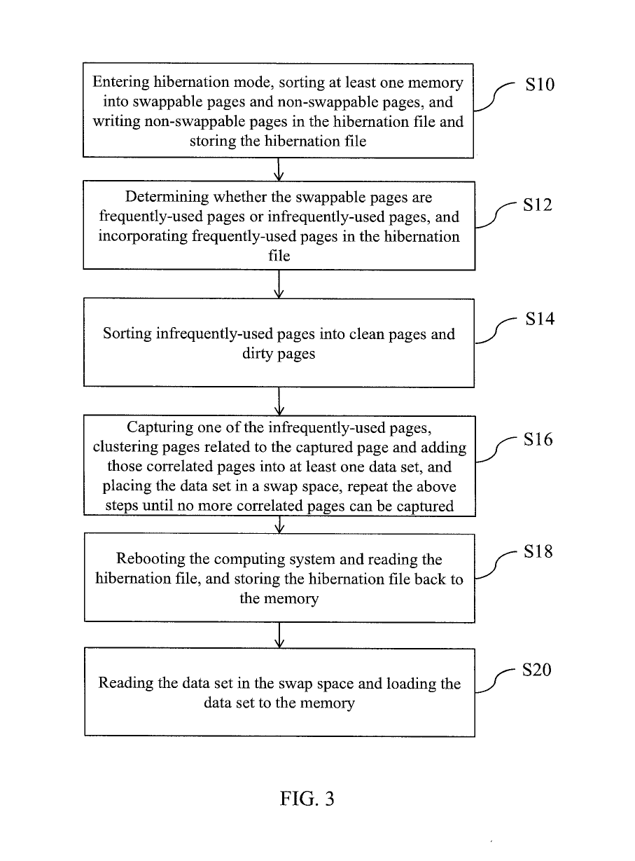

Referring to FIGS. 1-3, the method of the invention will be described in detail. The procedural steps of the method illustrated in the flow chart of FIG. 3 will be best understood with reference to the system block diagram of FIG. 1 and the tree chart of FIG. 2. As shown in FIG. 3, the method of the invention starts with the step S10. At Step S10, the computing system 1 enters the hibernation mode and the processor 10 of the computing system 1 sorts the pages in at least one memory 12 into a plurality of swappable pages and non-swappable pages. The processor 10 writes the non-swappable pages into the hibernation file 142 and then stores the hibernation file 142 in the storage device 14. Next, the method continues with step S12, in which the all swappable pages in the file system 146, swappable pages in the swap space 162, and the non-swappable pages in the memory 12, are determined to be frequently-used pages or infrequently-used pages. If those pages are determined to be frequently-used pages, those frequently-used pages are incorporated in the hibernation file 142. If the frequently-used pages are not located in the memory 12, the frequently-used pages are retrieved from the storage device 14 and then stored in the hibernation file 142. The frequently-used pages are defined as the pages required during the booting process of the computing system 1, or the pages having a high frequency of use or the pages having a high probability of use. The infrequently-used pages are defined as the pages that are rarely accessed after the booting process of the computing system 1 is completed, or the pages are cost-inefficient. An example of cost-inefficient pages may be pages that require the system to store them with a lot of time and electric power, while the booting time is not significantly shortened.

Furthermore, the step of determining whether the pages are frequently-used pages or infrequently-used pages at the step S12 can be carried out by a formula. An example of such formula is as follows:

$$\frac{seq rand}{seq} < access \qquad ( 1 )$$

Where seq denotes the cost incurred with the sequential reading process; rand denotes the cost incurred with the random reading process; access denotes the expectant access probability of the pages. If it is determined that the formula (1) is satisfied, the pages are determined as frequently-used pages, and are placed in the hibernation file 142. However, if it is determined that the formula (1) is unsatisfied, the pages are determined as infrequently-used pages. The cost expressed in the above formula is represented in terms of the time required for reading and writing the pages and the energy (power consumption) used for reading and writing the pages. The expectant access probability of each page can be deduced by long-term statistical process. It is to be noted that the above formula is used to indicate that the determination of whether a certain page is a frequently-used page for a certain system is related to the random reading speed and the sequential reading speed. As the energetic cost incurred with sequential reading process is getting closer to the energetic cost incurred with the random reading process, it is more unlikely that the page is determined to be frequently-used page.

In addition, in order to allow the computing system 1 to compulsorily swap out all of the infrequently-used pages of the memory 12, the following four strategies or measures may be used:
1. Call the functions of the operating system and swap the memory page out: For example, the memory management process shrink all memory in the Linux operating system may be called to compulsorily swap out the infrequently-used pages.
2. Allocate a large number of memory pages in the operating system and releasing those memory pages from the operating system afterwards: When a large number of memory pages are allocated in the operating system, the operating system indirectly swaps out infrequently-used pages. After the infrequently-used pages have been swapped out, the operating system releases those memory pages.
3. Allocate a large number of memory pages in the application program and write data into those memory pages, and releasing those memory pages afterwards: This would allow the operating system to indirectly swap out the infrequently-used pages. After the infrequently-used pages have been swapped out, the application program releases those memory pages.
4. Notify the operating system that a certain memory device is about to go off-line: When most of the memories are about to be removed, the operating system releases most of the memory pages, thereby efficiently swapping out infrequently-used pages.

Next, the method continues with step S14, in which the infrequently-used pages are sorted into clean pages and dirty pages, and the clean pages may be placed in the file system 146 of storage space 14 or discarded instead of being stored. Next, the process continues with step S16, in which the processor 10 captures one of the infrequently-used pages and repetitively adding pages that are related to the captured infrequently-used pages into at least one data set. In this embodiment, eight correlated pages are added to a data set, and the data set is placed in the swap space 144 of the storage device 14. As the pages that are related to the captured page are stored in the storage device 14, the pages stored in the file system 146 can be replicated to the data set of the swap space 144. At step S16, the captured dirty pages and the correlated dirty pages can be set to be dirty pages, thereby optimizing the spatial utilization of the swap space 144. At step S16, the pages that are related to an infrequently-used dirty page are added to at least one data set. The step S16 is repeated until no more dirty pages can be captured by the computing system 1. In other words, all of the infrequently-used pages are affiliated with at least one data set. As most of the infrequently-used pages have correlations with each other, the number of the captured pages is less than the number of frequently-used pages. When the processor 10 can not capture more pages, it is indicated that the processor 10 has affiliated all of the dirty pages of the memory 12 with at least one data set. Afterwards, those data sets are placed in the swap space 144 by a continuous accessing process.

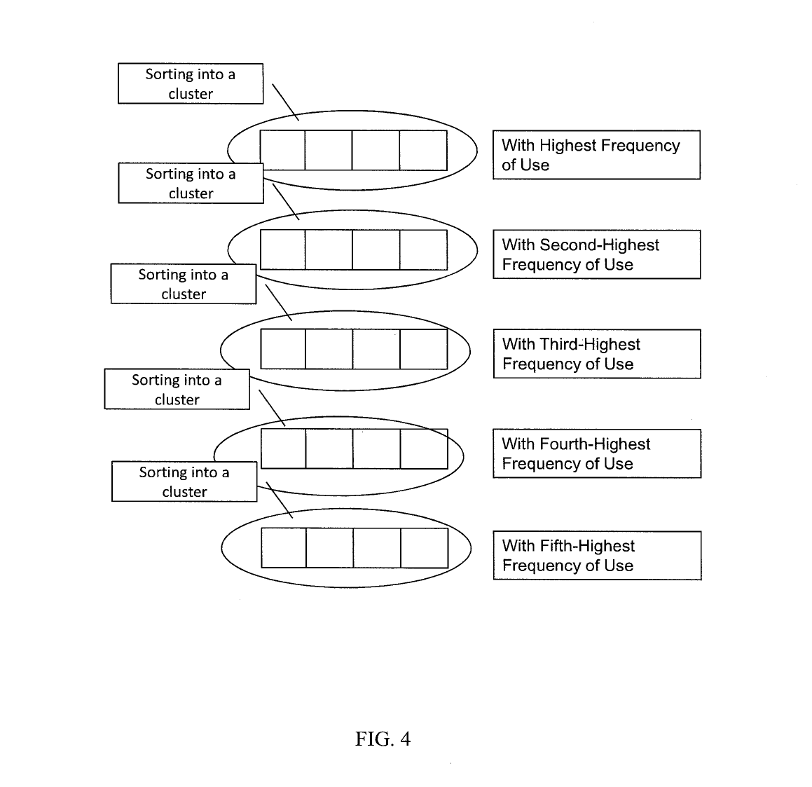

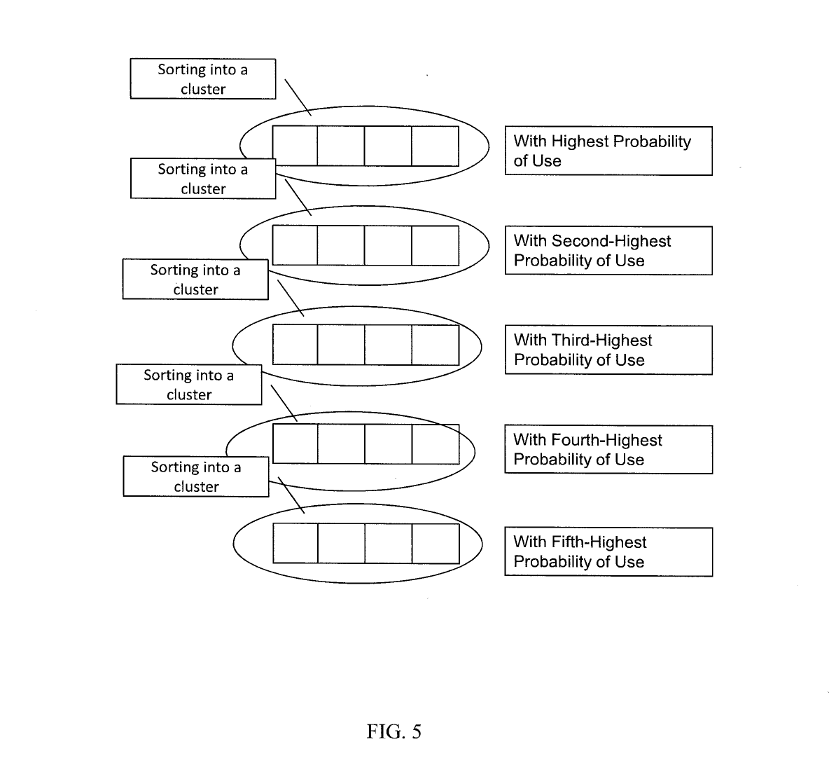

At step S16, the pages that are related to the captured infrequently-used page may be pages that are used in a continuous manner with the captured infrequently-used page, or pages having a logical address or a physical address adjacent to the captured infrequently-used page. Also, pages having a high utilization may be added to the data set to form a data cluster. Besides, the pages can be clustered in terms of frequency of use and sequenced as per the frequency of use, as shown in FIG. 4. The pages can be clustered in terms of probability of use and each cluster is added to at least one data set, as shown in FIG. 5. The probability of use, the frequency of use, the determination of whether the page is used frequently, or the determination of whether the page is used continuously, can be calculated statistically by way of keylogging. The clustering operation can be carried out by clustering pages that are frequently accessed during a period of time (for example, 15 seconds) after the computing system is booted can be counted. Or otherwise, the clustering operation can be carried out by clustering pages with the number of swap-in or swap-out of the page per second being lower than a threshold value, for example, 10. That is, the pages that are swapped in or swapped out less than ten times in one second are clustered. These settings may be altered according to user's demands Certainly, the data sets can be set to enable a plurality of continuously sequenced pages to be added to the data set by the least recently used (LRU) order.

By clustering correlated pages and adding the correlated pages into the data set, the page cache of the computing system 1 will become very efficient. By clustering pages having a high correlation, the booting process is able to read in the pages having a high correlation at one time, thereby promoting the booting speed of the computing system.

Next, the method continues with step S18. When the computing system 1 reboots, the processor 10 of the computing system 1 reads the hibernation file 142 from the storage device 14 and stores the hibernation file 142 back to the memory 12. Finally, the method continues with step S20, after the important pages in the hibernation file 142 of the storage device 14 are read, the processor 10 reads the data sets in the swap space 144 from the storage device 14 and loads the data sets to the memory 12.

While the invention has been described in terms of what are presently considered to be the most practical and preferred embodiments, it is to be understood that the invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the invention which is defined by the appended claims.

What is claimed is:

1. A method for optimizing a hibernation file, comprising the steps of:
when a computing system enters a hibernation mode, sorting at least one memory of said computing system into a plurality of swappable pages and a plurality of non-swappable pages, and enabling said computing system to write said non-swappable pages into the hibernation file and storing said hibernation file in at least one storage device; and
determining whether said swappable pages and pages stored in a file system and a swap space of the storage device of said computing system are frequently-used pages or infrequently-used pages, and incorporating said frequently-used pages in said hibernation file.

2. The method according to claim 1, wherein said frequently-used pages are pages required in a booting process of said computing system, or pages that are used frequently or pages that are highly likely to be used frequently.

3. The method according to claim 1, wherein if said swappable pages of the at least one said memory are not said frequently-used pages, said frequently-used pages in said storage device are retrieved therefrom and incorporated in said hibernation file.

4. The method for optimizing a hibernation file according to claim 1, wherein the step of determining whether said swappable pages are said frequently-used pages or said infrequently-used pages is carried out by a formula represented by:
$$\frac{seq - rand}{seq} < access$$
wherein said seq denotes a cost incurred with a sequential reading process, said rand denotes a cost denotes a cost incurred with a random reading process, said access denotes an expectant access probability of a page, and wherein if the formula is calculated to be satisfied, said swappable pages are determined to be said frequently-used pages, and if the formula is calculated to be unsatisfied, said swappable pages are determined to be said infrequently-used pages.

5. The method for optimizing according to claim 4, wherein said cost is represented by the time required for reading and writing the pages, the power consumption required for reading and writing the pages, or the throughput for the transmission of the pages.

6. A method for optimizing a booting process of a computing system by a swap space, comprising the steps of:
sorting infrequently-used pages of the computing system into a plurality of clean pages and dirty pages;
capturing one of said infrequently-used pages and adding pages that are related to the captured said infrequently-used page to at least one data set, and placing the at least one data set in a swap space of a storage device; and
repeating the above step until all of said infrequently-used pages are affiliated with at least one said data set and wherein said swap space is located in said storage device having high-speed random access characteristics.

7. The method according to claim 6, wherein said pages that are related to the captured said infrequently-used pages are pages that are frequently used in a continuous manner.

8. The method according to claim 6, wherein said pages that are related to the captured said infrequently-used pages are adjacent pages according to a least-recently-used order, and wherein the least-recently-used order is retained in a memory management subsystem of an operating system of said computing system, or retained in a memory management unit of said computing system.

9. The method according to claim 6, wherein said pages that are related to the captured said infrequently-used pages are pages having continuous logical addresses.

10. The method according to claim 6, wherein said pages that are related to the captured said infrequently-used pages are pages having continuous physical addresses.

11. The method according to claim 6, wherein said pages that are related to the captured said infrequently-used pages are pages having similar frequencies of use.

12. The method according to claim 6, wherein said pages that are related to the captured said infrequently-used pages are pages having similar probabilities of use.

13. A method for optimizing a booting process of a computing system by a swap space, comprising the steps of:
sorting a plurality of infrequently-used pages of the computing system into a plurality of clean pages and a, plurality of dirty pages; and
capturing one of said dirty pages and adding said dirty pages that are related to the captured said dirty page into a data set, and placing said data set in a swap space of a storage device, until all of said dirty pages are affiliated with at least one said data set, wherein said swap space is located in a device having high-speed random access characteristics.

14. The method according to claim 13, wherein said dirty pages that are related to the captured said dirty page are pages that are frequently used in a continuous manner.

15. The method according to claim 13, wherein said dirty pages that are related to the captured said dirty page are adjacent pages according to a least-recently-used order, and wherein the least-recently-used order is retained in a memory management subsystem of an operating system of the computing system, or retained in a memory management unit of the computing system.

16. The method according to claim 13, wherein said dirty pages that are related to the captured said dirty page are pages having continuous logical addresses.

17. The method according to claim 13, wherein said dirty pages that are related to the captured said dirty page are pages having continuous physical addresses.

18. The method according to claim 13, wherein said dirty pages that are related to the captured said dirty page are pages having similar frequencies of use.

19. The method according to claim 13, wherein said dirty pages that are related to the captured said dirty page are pages having similar probabilities of use.
